(19) United States
(12) Patent Application Publication
(10) Pub. No.: US 2010/0047559 A1
(43) Pub. Date: Feb. 25, 2010

(54) CORE-SHELL PARTICLES AND THEIR USE IN TOUGHENING POLYMER COMPOSITES

(75) Inventors: Felix N. Nguyen, Tacoma, WA (US); John C. Berg, Seattle, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: WASHINGTON, UNIVERSITY OF, Seattle, WA (US)

(21) Appl. No.: 12/489,311

(22) Filed: Jun. 22, 2009

Related U.S. Application Data
(60) Provisional application No. 61/074,409, filed on Jun. 20, 2008.

(51) Int. Cl. C08G 73/02; C08G 59/00; B32B 5/16

(52) U.S. Cl. 428/327; 525/185; 525/186

(57) ABSTRACT

Core-shell particles and methods of making these particles are described as well as polymer composites comprising these particles. Cores comprise polymerized vinyl monomers and shells comprise polyamine polymers, where the polyamine polymers are covalently attached to the core. Use of these particles in polymer composites, such as epoxies, may impart improved toughness properties to the polymer composites.

### CROSS-REFERENCE TO RELATED APPLICATION

This application claims the benefit of Provisional Application No. 61/074,409, filed Jun. 20, 2008, which is incorporated herein by reference in its entirety.

### BACKGROUND

Filler—(e.g., particulate or fiber) reinforced polymer or polymeric composites have appeared in many applications where mechanical properties and light weight are equally important. When working with polymeric composites, two challenges are usually encountered: (1) material design requires both good adhesion between the matrix and reinforcements to achieve an overall high stiffness and good matrix toughness to sustain impact loads, leading to overall high fracture resistance, and (2) property optimization that is often associated with fabrication techniques (e.g., avoidance of fiber-fiber touching or particle aggregation), performance in hostile environments (e.g., high temperature and high humidity), and sometimes electrical conductivity. To meet the adhesion requirement in the former, there cannot be voids at the interface but all that is required of the composite to attain its maximum stiffness potential is that there be molecular contact between the two phases, allowing applied loads to be transferred from the matrix to the reinforcements. The dominant effect of the reinforcements is the interfacial stress concentrations they induce due to the discontinuities they produce in the bulk matrix, i.e., the modulus mismatch between the two phases. The destructive action of these stress concentrations, which leads to interfacial failure, may be aided by two additional effects: chemical embrittlement of the matrix induced by the reinforcements and local residual stress due to differences between the thermal expansion coefficients of the matrix and the reinforcements. As a result, the interphase is often the most highly stressed region in the composite material and is vulnerable to crack initiation when loads are applied.

In view of this vulnerability, it makes sense to reduce these stress concentrations by placing a material of intermediate modulus or a ductile material between the reinforcements and the matrix. The former involves lowering the modulus ratio of any two neighboring components and is sometimes called a “graded-modulus interphase.” In the latter, local deformation capability is built into the interfacial region so that the stress concentrations are damped out, at least partially. In any case, since the layer is applied from a solution, it also might heal flaws in the reinforcements, increasing their intrinsic strength from the uncoated reinforcements. In addition, this interlayer binds the reinforcements to the matrix, i.e., acts as an adhesion promoter. The most commonly used adhesion promoters are silane coupling agents, which bind to the surface and whose organofunctional (end) groups dissolve into and often react with the polymer matrix upon curing.

Candidate silanes can dramatically promote adhesion for stress transfer, but do not have any effect on the composite's modulus. The reason is that the elastic stiffness (Young's modulus) is defined as the strain approaches zero, which depends only on the reinforcement loading. Increasing adhesion, however, is at the expense of fracture toughness attributable to an increase in interfacial matrix embrittlement, allowing cracks to initiate in these regions and propagate into the resin-rich areas. This is commonly seen in polymeric composites. Recall that fracture toughness is the resistance to crack growth, different from toughness defined as the area under the tensile stress-strain curve, which depends on the adhesion level. Nevertheless, the terms are sometimes used interchangeably in some contexts. Above all, it is necessary to have an optimized adhesion level so that there is a balance between stiffness and fracture toughness to sustain both tensile/compressive/shear and impact loads, respectively.

Recently, hyperbranched (HB) and dendrimeric polymers have shown promise as tougheners. Some reported that when epoxy-terminated onion-structured HB polymers were incorporated in epoxy, fracture toughness increased at the expense of stiffness. Frohlich et al., Polymer 45, 2155-64 (2004); Boogh et al., Polymer 40, 2249-61 (1999). Since only terminal groups reacted with the epoxy, the internal HB network became ‘hollow’, permitting the absorption of crack energy (stress relief), but at the same time allowing applied loads to be transferred to a much ‘softer’ phase, which leads to a substantial reduction in the overall stiffness. Realizing this limitation, others have proposed the use of HB and dendrimeric polyamidoamine (PAMAM) polymers, which allow multileveled shell crosslinks. Yiyun et al., Polym. Int'l 54, 495-99 (2005); Dodiuk et al., Composite Interf 11, 453-69 (2004); Dodiuk, et al., A. Adhesion Sci. Technol. 18, 301-11 (2004). Adhesion enhancements of epoxy to aluminum surfaces, aramid (Kevlar®) and phenylene-benzobisoxazole (Zylon®) fabrics were found at very low polymer concentrations. Higher concentrations of HB PAMAM, however, led to a reduction in adhesion strength due to plasticization. Dodiuk et al., Composite Interf 11, 453-69 (2004). In addition, these polymers, especially in the dendrimeric form, are expensive.

Methods of improving properties of polymer composites, such as epoxies, that allow for enhancement of both fracture toughness and stiffness of the composite are needed. Such methods would ideally be economical and applicable to a variety of composite types.

### SUMMARY

Core-shell particles are described herein that may be used to toughen polymer composites, such as those comprising epoxy. Such polymer composites may be used in areas such as coatings, adhesives, and biomedical applications.

Accordingly, the present invention provides a particle comprising: (a) a core comprising a plurality of polymerized vinyl monomers; and (b) a shell comprising at least one polyamine polymer, wherein each polyamine polymer comprises or consists of a plurality of primary amines, a plurality of secondary amines, and optionally at least one tertiary amine, and each nitrogen atom of each primary amine, secondary amine, and optional tertiary amine is separated by an alkylene group.

Also provided is a method of making a particle, comprising polymerizing a plurality of vinyl monomers in the presence of a non-aqueous polar solvent and a plurality of polyamine polymers, wherein each polyamine polymer comprises or consists of a plurality of primary amines, a plurality of secondary amines, and optionally at least one tertiary amine, and each nitrogen atom of each primary amine, secondary amine, and optional tertiary amine is separated by an alkylene group, to provide a particle comprising: (a) a core comprising a plurality of polymerized vinyl monomers; and (b) a shell comprising at least one polyamine polymer, wherein each polyamine polymer comprises or consists of a plurality of primary amines, a plurality of secondary amines, and optionally at least one tertiary amine, and each nitrogen atom of each primary amine, secondary amine, and optional tertiary amine is separated by an alkylene group. Particles made by this process are also contemplated, and such particles may be employed in any method herein.

Polymer composites are also contemplated by the present invention, such as a polymer composite comprising a plurality of particles of the present invention.

An epoxy having a fracture toughness (K_{IC}) of at least about 1.3 MPa.m^{0.5} and a flexural modulus of at least about 2900 MPa is provided by the present invention.

A method for making a polymer composite is also contemplated, the method comprising combining a plurality of particles of the present invention with an amine-reactive polymer and a curing agent to produce a polymer composite comprising a plurality of particles of the present invention.

Also provided are methods of reducing water-uptake of an epoxy comprising a particle of the present invention, comprising adding about 5-15 parts by weight of styrene monomers to said epoxy prior to curing.

Methods of improving the flexural modulus of an epoxy comprising a particle of the present invention are also contemplated, comprising adding about 5-15 parts by weight of styrene monomers to said epoxy prior to curing.

### DESCRIPTION OF THE DRAWINGS

The foregoing aspects and many of the attendant advantages of this invention will become more readily appreciated as the same become better understood by reference to the following detailed description, when taken in conjunction with the accompanying drawings.

FIG. 1 is a depiction of the preparation of polystyrene (PS) core-polyethyleneimine (PEi) dendrimer shell particles of the present invention. The variables m, p, r and t may be the same or different. In addition, one or more nitrogen atoms may be protonated, depending on pH.

FIGS. 2A-2D show scanning electron microscope (SEM) images of PS core (2A, 2B) and PS-PEi (2C, 2D) particles. Some small particles (2B, 2D) were formed when concentrating the dispersions before mixing with epoxy. These particles might be the product of unreacted materials.

FIG. 3 is a Fourier-transform infrared spectrogram of cleaned PS-PEi particles. Both aromatic and amino peaks are clearly shown. This indicates that there are core-shell linkages in these particles.

FIG. 4 is an energy dispersive x-ray spectroscopy (EDS) spectrum of PS-PEi particles with the core-to-shell ratio of 5:1. The peak height ratio of carbon to nitrogen was approximately 2.5. The observed peak ratio indicated that there was a thick shell for this type of particle.

FIGS. 5A-5I are images of fracture toughness surfaces of PS-PEi particles in epoxy: 10 wt % particles at a core-to-shell ratio of 5:1 (5A-5C), 5:1 (5D-5F) and 25 wt % MX125 (5G-5I) samples. A separation between the laser cut and razor tips (5A, 5D, 5G) evidences these sample are tougher than the neat. After the advancement of the initial crack tip, the surface of the 5:1 PS-PEi has many cracks, propagating randomly (5B), as opposed to in parallel planes shown in the other two samples (5E, 5H). Since there is a competing formation of homogeneous or core (PS) particles in the reaction vessel, the higher the core-to-shell ratio, the more likely their presence is found (5F). Particle breaking and dramatic particle-matrix interface stretching (5C, 5F), as opposed to massive shear-band formation (5I), indicated by the white area around these rubber particles, and some degree of particle stretching, are responsible for a significant increase in K_{IC} in the PS-PEi samples compared to the MX125 samples.

FIG. 6 is a drawing that represents a single-edge notch-bend (SENB) specimen. The notch was created by a laser cutter to a length of 6 mm, followed by forcing a razor blade to the slot and tapping it. Final crack length a is about 8 mm.

FIGS. 7A-7D show various graphs of fracture toughness data (7A, 7C) and flexural data (7B, 7D) of toughened epoxy samples. PEi, PS, MX125 (CSR) and PS-PEi particles were loaded at 2.5-5%, 3%, 5-25% and 2.5-10 wt %, respectively. Variation in flexural strength is due to micro roughness of the edges of the machined sides, while that in K_{IC} is due to the uncertainty of crack length measurement. All samples show an increase in fracture toughness from the neat epoxy (7C). PS-PEi samples are tougher than CSR samples at 5 wt % loading. A substantial increase in K_{IC} is shown with the 10 wt % PS-PEi particle sample than the 25 wt % CSR MX125. In addition, a large increase was seen in flexural/tensile modulus as PS-PEi particle loading was increased (7D), but no drop in the PS- and PEi-toughened epoxy samples. The opposite was found with MX125 samples.

FIGS. 8A-8D show fracture toughness surfaces of neat (8A), 3 wt % PS (8B)-, 5 wt % PEi (8C)—, and 10 wt % PS-PEi particle (8D)-toughened epoxy samples. Arrows indicate crack front propagation direction. In all cases, cracks propagate in parallel planes, except the case of PS-PEi particles, where cracks are directed in many random paths.

FIG. 9 are images of polystyrene (PS) particles, which are shown to evoke energy-absorbing mechanisms. Particles appeared to be porous, allowing epoxy molecules to penetrate. This is evidenced from ‘tooth-like’ formation at the interface. Particle stretching/breaking and matrix cavitation are the main toughening mechanisms.

FIGS. 10A and 10B shows a comparison of particle-induced energy-absorbing mechanisms in 10 wt % PS-PEi particle-(10A) and 25 wt % MX125-toughened (10B) epoxy samples. Dramatic interface stretching and particle-breaking mechanisms in the former are more effective than massive shear-band formation and possibly particle-stretching mechanisms found in the latter.

FIG. 11 shows a flexural fracture surface comparison among neat, 10 wt % MX125 and 10 wt % PS-PEi particle epoxy samples. The surface of PS-PEi particle containing epoxy shows many cracks in both tension and compression regions, while in other surfaces cracks propagate in parallel planes. The PEi dendrimer's apparent capability to direct cracks to go through core particles or diverting them in many paths leads to a ‘rock-like’ surface, which is thought to enhance stiffness of the toughened epoxy.

FIGS. 12A-12D show graphs of fracture toughness data (12A, 12C) and flexural data (12B, 12D) of toughened epoxy samples. MX125 and MX156 (CSR) and PS-PEi particles with the core-to-shell ratio of 2:1, 5:1 and 10:1 were loaded at 5-25 wt %, 2.5-5 wt %, 2.5-10 wt % and 5-10 wt %, respectively. Variation in flexural strength is due to micro roughness of the edges of the machined sides, while that in K_{IC} is due to the uncertainty of crack length measurement. All samples show an increase in fracture toughness from the neat epoxy (12C). PS-PEi particle samples are tougher than CSR samples at 5 wt % loading. A substantial increase in K_{IC} is shown with the 10 wt % PS-PEi particle samples than with the 25 wt % MX125. In general, K_{IC} decreases as the core-to-shell ratio increases among PS-PEi particle samples. Furthermore, it was postulated that there was a threshold loading or critical particle interspacing in that K_{IC} remains unchanged. This is seen among the 5 wt % PS-PEi particle samples as well as 2.5 and 5 wt % PS-PEi particle 2:1 and 5:1 samples and the 10 wt % MX156 samples. Furthermore, a large increase in flexural/tensile modulus was observed as PS-PEi particle loading increased, especially at 10 wt % loading. The opposite was found with MX125 and MX156 samples.

FIGS. 13A and 13B are graphs showing data pertaining to the weight percent of water uptake (13A) and flexural modulus comparison (13B) of selected PS-PEi particle-containing epoxy samples submerged in 70° C. water for 25 and 100 hrs. A similar amount of water absorption was observed for all samples after 25 hr. All samples showed less than 1% increase in weight after 100 hr, and PS-PEi particle containing samples outperformed the neat. For all samples, a reduction less than 10% were obtained. Even so, PS-PEi particle samples still significantly outperformed both the neat and CSR samples.

FIG. 14 shows a comparison of water uptake for neat, MX156 reinforced, MX125 reinforced, 5:1 PS-PEi particle reinforced and 5:1 PS-PEi particle/10 pbw styrene monomer reinforced epoxies. In all systems, a variation of less than 2% was observed. Styrene monomer addition significantly decreased water uptake.

FIG. 15 is a graph depicting data comparing the flexural modulus of 10 pbw PS-PEi particle toughened epoxies with neat epoxy specimens in dry and hot-wet environments. The effect of the addition of 10 pbw styrene to the systems is shown in the columns at the right.

### DETAILED DESCRIPTION

As noted above, particles of the present invention comprise a core and a shell, where the core and shell are joined by covalent linkages. As such, the particles may be referred to as core-shell particles, or simply “particles.” One aspect of the present invention contemplates a core-shell particle comprising: (a) a core comprising a plurality of polymerized vinyl monomers; and (b) a shell comprising at least one polyamine polymer, wherein each polyamine polymer comprises or consists of a plurality of primary amines, a plurality of secondary amines, and optionally at least one tertiary amine, and each nitrogen atom of each primary amine, secondary amine, and optional tertiary amine is separated by an alkylene group. In certain embodiments, at least one, most (greater than 50%), or each polyamine polymer is covalently coupled to the core. Typically, the covalent bond is an —NH—CH₂— bond, but a tertiary amine bond is also contemplated (that is, —NR—CH₂—). Other covalent bonds may be employed as well (e.g., amide, ether, thioether, ester). Examples of vinyl monomers, polyamine polymers, alkylene groups, particle diameters, particle zeta potentials and other particle characteristics and properties are described herein. Any core-shell particle of the present invention may comprise one or more of these exemplified characteristics or properties, or may specifically exclude any such characteristic or property. Moreover, any such core-shell particle may be employed in any method described herein.

Also contemplated are methods of making the core-shell particles described herein. For example, certain embodiments contemplate a method of making a core-shell particle comprising polymerizing a plurality of vinyl monomers in the presence of a non-aqueous polar solvent and a plurality of polyamine polymers, wherein each polyamine polymer comprises or consists of a plurality of primary amines, a plurality of secondary amines, and optionally at least one tertiary amine, and each nitrogen atom of each primary amine, secondary amine, and optional tertiary amine is separated by an alkylene group, to provide a core-shell particle comprising: (a) a core comprising a plurality of polymerized vinyl monomers; and (b) a shell comprising at least one polyamine polymer, wherein each polyamine polymer comprises or consists of a plurality of primary amines, a plurality of secondary amines, and optionally at least one tertiary amine, and each nitrogen atom of each primary amine, secondary amine, and optional tertiary amine is separated by an alkylene group. In certain embodiments, at least one, most (greater than 50%), or each polyamine polymer is covalently coupled to the core. Typically, the covalent bond is an —NH—CH₂— bond, but a tertiary amine bond is also contemplated (that is, —NR—CH₂—). Other covalent bonds may be employed as well (e.g., amide, ether, thioether, ester).

As used herein, “polymerized vinyl monomers” refers to monomers having at least one polymerizable carbon-carbon double bond. In certain embodiments, polymerized vinyl polymers are further defined as elastomers, thermoplastic monomers, or a combination thereof. As used herein, “elastomer” refers to a rubbery material which, when deformed, will return to approximately the original dimensions in a relatively short time. Typically, an elastomer, when above its T_{g}, will stretch rapidly under tension, reaching high elongations (e.g., 200-1000% after curing of an unfilled elastomer per standard elongation testing procedures) with low damping. An elastomer has generally high tensile strength and high modulus when fully stretched. As used herein, the term “thermoplastic” refers to polymers that are reversibly deformable (able to be softened) after being heated above their softening or glass transition temperatures and then cooled; these materials are typically capable of being repeatedly melt processed in plastic manufacturing machinery such as, for example, injection molding, extrusion, blow molding, compression molding and rotational molding. Copolymers of thermoplastic monomers and elastomers are also contemplated and are well-known in the art. In certain embodiments, the vinyl monomers are selected from the group consisting of styrene, methylmethacrylate (MMA), benzylmethacrylate (BMA), butadiene sulfone (BSF) and 1,3,5,7-tetravinyl-1,3,5,7-tetramethylcyclotetrasilane. Other vinyl monomers are described in U.S. Pat. No. 6,573,313, incorporated herein by reference in its entirety. Many vinyl monomers are commercially available. A plurality of polymerized vinyl monomers may comprise one or more than one type of vinyl monomer. Moreover, a plurality of polymerized vinyl monomers may form a thermoplastic core or a thermoset core.

The polyamine polymer employed in any method herein may be any polyamine polymer known in the art that comprises or consists of a plurality of primary amines, a plurality of secondary amines, and optionally at least one tertiary amine, and each nitrogen atom of each primary amine, secondary amine, and optional tertiary amine is separated by an alkylene group. In certain embodiments, a polyamine polymer does not comprise an amide bond. As used herein, “alkylene” refers to a linear, unsubstituted hydrocarbon chain ranging from 2-20 carbon atoms. The chain in any alkylene unit may be, or may be at most or at least, 2, 3, 4, 5, 6, 7, 8, 9, 10, 11, 12, 13, 14, 15, 16, 17, 18, 19, or 20 carbons in length, or any range derivable therein.

The polyamine polymer may be a linear polyamine polymer or a branched polyamine polymer, or a combination thereof. In certain embodiments, the minimum molecular weight, or minimum average molecular weight, of a polyamine polymer is about 2,000 Da. In certain embodiments, the minimum molecular weight, or minimum average molecular weight, of a polyamine polymer is about 5,000 Da. Polyamine polymers may further comprise a cyclic polyamine structure. A non-limiting example of a linear polyamine polymer is a linear polyalkyleneamine polymer. As used herein, a “linear polyalkyleneamine polymer” refers to a linear polyamine polymer containing primary and secondary amines, each separated by an alkylene unit. Linear polyalkyleneamine polymers are commercially available (e.g., Akzo Nobel Functional Chemicals).

A non-limiting example of a branched polyamine polymer is branched polyethyleneimine, having a formula of

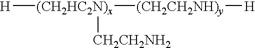

wherein x and y are each greater than 2 and may be the same or different. A branched polyamine polymer may be further defined as a hyperbranched polyamine polymer. As used herein, “hyperbranched” refers to a highly branched polyamine polymer whose branches do not exhibit any patterned regularity. Branched and hyperbranched polyamine polymers are also commercially available.

In certain embodiments, the polyamine polymer is a dendrimer. As used herein, a “dendrimer” refers to a branched polymer that exhibits branches of patterned regularity. In certain embodiments, the shell comprises a polyalkyleneimine dendrimer, such as a polyethyleneimine (PEi) dendrimer. Such dendrimers are commercially available (e.g., Sigma Aldrich). A PEi dendrimer may be characterized, for example, by its molecular weight. In certain embodiments, the minimum average molecular weight is about 2,000 Da. In certain embodiments, the minimum average molecular weight of is about 5,000 Da. In certain embodiments, the average molecular weight is about, at most about, or at least about 2,000, 5,000, 10,000, 15,000, 25,000, 50,000, 75,000, 100,000, 150,000, 200,000, 250,000, 300,000, 350,000, 400,000, 450,000, 500,000, 550,000, 600,000, 650,000, 700,000, or 750,000 Da, or more, or any range derivable therein. In particular embodiments, the average molecular weight is about 750,000 Da.

It should be noted that the structure of polyethyleneimine-containing polymers is not always clear, and may comprise aspects of linear, cyclic, branched, hyperbranched, or dendrimeric characteristics. In general, each commercial supplier of this product offers a description of the structure sold. This is also true of other polyalkyleneimines as well.

Core-shell particles of the present invention may have a diameter, or an average diameter, of less than about 500 nm. In certain embodiments, the diameter or average diameter ranges between about 200-300 nm. In certain embodiments, the diameter or average diameter is about, at least about, or at most about 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, or 500 nm, or any range derivable therein.

Core-shell particles of the present invention may have a zeta potential in isopropyl alcohol ranging between about 60-70 mV. In certain embodiments, the zeta potential may be about 60, 65, or 70 mV, or any range derivable therein.

The weight ratio of vinyl monomer to polyamine polymer in methods of making core-shell particles of the present invention, as well as in the final core-shell particles themselves, may range between about 1:1 to about 50:1. In certain embodiments, the weight ratio ranges from about 2:1 to 10:1. In particular embodiments, the weight ratio is about 5:1.

In particular embodiments of any core-shell particle or method of the present invention, the vinyl monomer is further defined as styrene, the polyamine polymer is further defined as PEi dendrimer, and the weight ratio of styrene to PEi is about 5:1.

In methods comprising use of a non-aqueous polar solvent, such a solvent may have a boiling point above about 45° C. In certain embodiments, the non-aqueous polar solvent is further defined as an alcohol, such as isopropyl alcohol. In certain embodiments, the non-aqueous polar solvent may have a boiling point that is above room temperature and is below the temperature at which polymerization takes place. Non-limiting examples of non-aqueous polar solvents include acetone, n-hexane, methanol and ethanol.

Polymerization methods typically entail radical initiated polymerization, a process that is well-known in the art. See, e.g., Li. et al., Langmuir 18, 8641-46 (2002); Zhu et al., Bioconjugate 16, 139-146 (2005). Initiators that may be employed are well-known in the art, such as peroxides (e.g., tert-butyl hydroperoxide). See also U.S. Pat. No. 6,573,313, incorporated herein by reference in its entirety, for non-limiting examples of initiators and methods of radical initiated polymerization.

Core-shell particles made via any process described herein are also contemplated, and may be used in any method discussed herein.

Polymer composites comprising core-shell particles of the present invention are also contemplated. As used herein, a “polymer composite” comprises a polymer and a core-shell particle of the present invention. In such a composite, a plurality of primary or secondary amines of the particle are covalently bound to a polymer of the composite. The covalent bonding may be of one type, or more than one type. A polymer composite may comprise more than one type of polymer and more than one type of particle of the present invention. In certain embodiments, the polymer composite is further defined as an epoxy comprising a plurality of particles. As used herein, an “epoxy” refers to a copolymer formed from the reaction of a 1,2-epoxide-containing resin with a polyamine. Numerous types of epoxy resins are known in the art and are commercially available (e.g., Miller-Stephenson Chemical). Non-limiting examples of resins include combinations of bisphenol A and epichlorohydrin. Polyamines that may react with resins are also well-known in the art and are commercially available (e.g., Albemarle Corp.). Any polymer composite of the present invention may comprise an epoxy.

In certain embodiments, a polymer composite comprises at least 0.5 weight percent of core-shell particles. In certain embodiments, the polymer composite comprises from about 2-25 weight percent of particles. In particular embodiments, the polymer composite comprises at least about 10 weight percent of particles. A polymer composite may further comprise styrene monomers, which are commercially available. For example, a polymer composite may comprise about 5-15 parts by weight of styrene monomers. In any embodiment herein, a polymer composite may comprise about, at most about, or at least about 5, 6, 7, 8, 9, 10, 11, 12, 13, 14, or 15 parts by weight of styrene monomers, or any range derivable therein.

Another aspect of the present invention is an epoxy having a fracture toughness (K_{IC}) of at least about 1.3 MPa.m^{0.5} and a flexural modulus of at least about 2900 MPa. The epoxy may further comprise core-shell particles, as described herein, such as about 10 wt % of such particles. The epoxy may further comprise about 5-15 weight percent of styrene monomers.

Also contemplated by the present invention is a method for making a polymer composite, comprising combining a plurality of core-shell particles with an amine-reactive polymer and a curing agent to produce a polymer composite comprising core-shell particles. Such particles may comprise (a) a core comprising a plurality of polymerized vinyl monomers; and (b) a shell comprising at least one polyamine polymer, wherein each polyamine polymer comprises or consists of a plurality of primary amines, a plurality of secondary amines, and optionally at least one tertiary amine, and each nitrogen atom of each primary amine, secondary amine, and optional tertiary amine is separated by an alkylene group. In certain embodiments, at least one, most (greater than 50%), or each polyamine polymer is covalently coupled to the core. Typically, the covalent bond is an —NH—CH₂— bond, but a tertiary amine bond is also contemplated (that is, —NR—CH₂—). Other covalent bonds may be employed as well (e.g., amide, ether, thioether, ester).

As used herein, an “amine-reactive polymer” is a polymer comprising a plurality of one or more functional groups that may react with a primary or secondary amine. The term “functional group” generally refers to how persons of skill in the art classify chemically reactive groups. Non-limiting examples of functional groups that may react with a primary or secondary amine include epoxide, isocyanate, isothiocyanate, acyl halides and N-hydroxysuccinimide esters.

The polymer composite may comprise an epoxy. The weight percent of particles combined with the amine-reactive polymer and curing agent may be at least about 0.5%. In certain embodiments, the weight percent is at least about 10%. The weight percent may range from about 2.5-25%. In particular embodiments regarding a polymer composite, such as one comprising an epoxy, the particles are further defined as particles having a polystyrene (PS) core and a polyethyleneimine (PEi) dendrimer shell. In certain embodiments, at least one, most (greater than 50%), or each PEi dendrimer is covalently coupled to the core. Typically, the covalent bond is an —NH—CH₂— bond, but a tertiary amine bond is also contemplated (that is, —NR—CH₂—).

In methods of making polymer composites, the plurality of core-shell particles may be dispersed in a non-aqueous polar solvent prior to combination with the amine-reactive polymer and the curing agent. The particle concentration (grams of sold/gram of dispersion) may range, for example, from about 10-15%. The method may further comprise removing the non-aqueous polar solvent. For example, certain embodiments contemplate heating the mixture formed by the combination of the plurality of particles dispersed in a non-aqueous polar solvent, amine-reactive polymer and curing agent at a temperature sufficient to remove the non-aqueous polar solvent. Methods of making polymer composites may further comprise a step of adding about 5-15 parts by weight (pbw) of styrene monomers. A further step that may be employed is curing the polymer composite.

Also contemplated are methods of reducing water-uptake of a polymer composite comprising a core-shell particle, such as a polymer composite comprising an epoxy. Such methods may comprise adding styrene monomers, e.g., 5-15 parts by weight, to said epoxy prior to curing. Water-uptake may be reduced in comparison to core-shell particle containing polymer composites that do not contain styrene monomers, or to substances that do not contain either particles or monomers (e.g., neat epoxy). Water-uptake may be reduced by about, at most about, or at least about 10, 15, 20, 25, 30, 35, 40, 45, 50, 55, 60, 65, 70, 75, 80, 85, 90, or 100%, or any range derivable therein.

Methods of improving the flexural modulus of a polymer composite comprising a core-shell particle, such as a polymer composite comprising an epoxy, are also contemplated by the present invention. Such methods may comprise adding styrene monomers, e.g., 5-15 parts by weight, to the polymer composite prior to curing. Flexural modulus may be improved relative to the particle-containing polymer composite without styrene monomers, or to the particle composite alone (e.g., neat epoxy). Flexural modulus may be improved by about, at least about, or at most about 10, 15, 20, 25, 30, 35, 40, 45, 50, 55, 60, 65, 70, 75, 80, 85, 90, or 100%, or any range derivable therein. Flexural modulus may be improved under hot-wet conditions, such as submersion of the polymer composite in water at temperatures ranging from 75-85° C. The hot-wet conditions may be submersion in water at temperatures of about, at most about, or at least about 75, 76, 77, 78, 79, 80, 81, 82, 83, 84, or 85° C., or any range derivable therein.

The use of the term “or” in this application is used to mean “and/or” unless explicitly indicated to refer to alternatives only or the alternatives are mutually exclusive. It is specifically contemplated that any listing of items using the term “or” means that any of those listed items may also be specifically excluded from the related embodiment.

Throughout this application, the term “about” is used to indicate that a value includes the standard deviation of error for the device or method being employed to determine the value.

As used herein, “a” or “an” means one or more, unless clearly indicated otherwise.

The terms “comprise,” “have” and “include” are open-ended linking verbs. Any forms or tenses of one or more of these verbs, such as “comprises,” “comprising,” “has,” “having,” “includes,” and “including,” are also open-ended. For example, any method that “comprises,” “has,” or “includes” one or more steps is not limited to possessing only those one or more steps and also covers other unlisted steps.

It is specifically contemplated that any limitation discussed with respect to one embodiment of the invention may apply to any other embodiment of the invention. Furthermore, any composition (e.g., particle) of the invention may be used in any method of the invention, and any method of the invention may be used to produce or to utilize any composition of the invention. For example, any method discussed herein may employ any core-shell particle described herein.

### EXAMPLES

It is noted that in Examples 1-6 below and the accompanying figures, “PEi” refers to PEi dendrimer.

### Example 1

### Preparation and Characterization of PS-PEi Particles

Materials. Dried, 12.5 (avg.)-branched polyethyleneimine (PEi) dendrimer (avg. MW=750,000), t-butyl hydroperoxide (TBHP) (70 wt % in H₂O) and styrene monomers were purchased from Sigma Aldrich (St. Louis, Mo.).

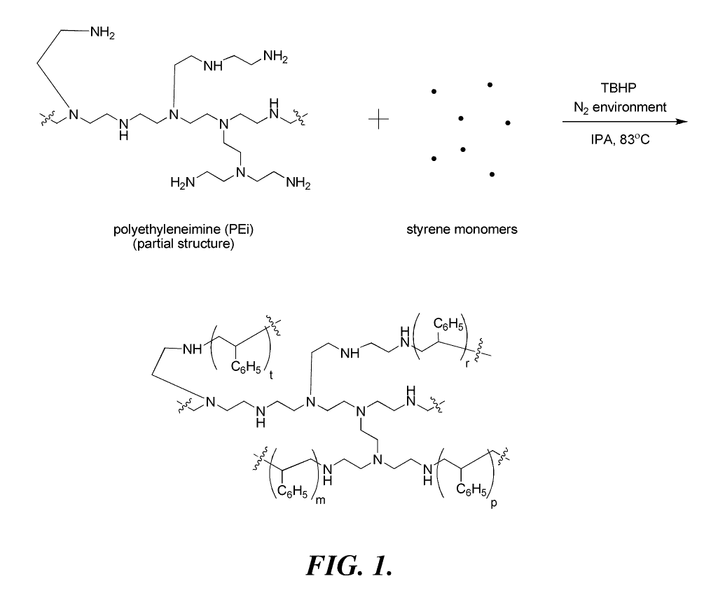

Procedure. Preparation of PS-PEi particles is show in FIG. 1. PEi gel (50 g) was dissolved in 1 L of isopropyl alcohol (IPA) in a 2 L beaker. Styrene monomer was added to the beaker to achieve the desired core-to-shell weight ratio: in this case, 5:1 by weight. The well-stirred mixture was transferred to a 3 L reactor vessel equipped with water-jacket, thermometer, overhead stirring system and nitrogen gas flow. The reactor volume was filled up with an additional amount of IPA. After the reactants were stirred at 320 rpm and purged with nitrogen for 45 min, 4 mL of TBHP were added dropwise, and the temperature was increased to 83° C. The formation of particles was noticeable as the mixture turned white at 72° C. The reaction was allowed to complete after 2.5 hr.

The reaction dispersion (50 mL) was centrifuged at 150,000 rpm and washed with IPA multiple times to remove any unreacted material. The collected particles were dried in an oven at 60° C. for 24 hr. Cleaned particles were ground with KBr and examined by FTIR to confirm the presence of the core-shell linkages. The remaining dispersion was then poured into a 5 L flask and heated under vacuum to 1 L. Particle concentration (grams of solid/gram of dispersion) was determined, which typically resulted in 10-15 wt %.

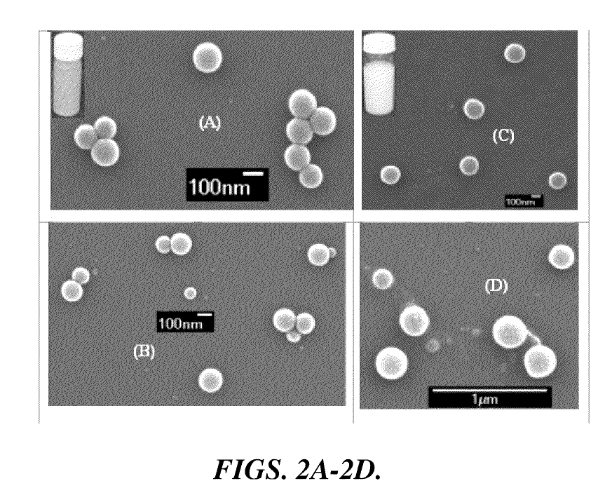

When the final dispersions were heated under vacuum to evaporate some IPA, some small particles formed (FIGS. 2B, 2D). It is thought, though not confirmed, that they were nucleated during heating due to excess reactant materials present in the final dispersion and/or coalescence of particles, followed by size disproportionation. These small particles are believed to neither contribute to nor detract from the energy-absorbing effects discussed below.

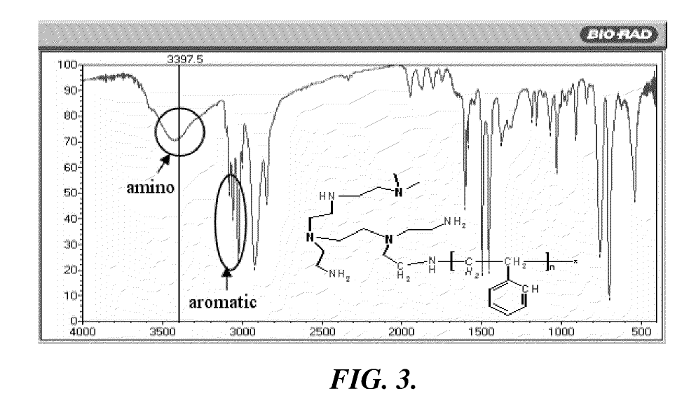

Analysis. Without being bound by theory, it is thought that due to incompatibility with the non-aqueous polar solvent, polystyrene (PS) folds and forms a core as the reaction progresses, while the attached PEi extends out as a shell. The core-shell linkages have been confirmed by FTIR, as shown in FIG. 3, where both amino and aromatic peaks are observed.

Following completion of the grafting step, a drop of the reaction dispersion was diluted with IPA and placed on a silicon wafer glued to an SEM stool. The sample was sputter-coated with platinum and examined using a JEOL JSM-7000F (Tokyo, Japan) scanning electron microscope for size and size distribution. FIGS. 2A, 2C show the reaction solutions of PS-only particles produced in a similar procedure and the PS-PEi particles after 5 hr and 2.5 hr, respectively, as well as SEM micrographs of these particles. The polymerization reaction of PS approached completion after 5 hr, giving the desired particle size. The PS particles were approximately 100 nm in diameter, while those of the PS-PEi particles were 200-250 nm (FIGS. 2A, 2C). Typically, the grafting thickness and overall size of the PS-PEi particles depend on the starting materials. In repeated experiments at 5:1 styrene monomer:PEi by weight, particle sizes ranged from 250-300 nm.

The zeta potential of the particles in IPA was measured using a ZetaPALS® (Brookhaven Instruments Corp., Holtsville, N.Y.) light scattering system. It was found that the PS particle dispersion was stable, as indicated by a high zeta potential in IPA of +110 mV. On the other hand, a more stable dispersion was observed with the PS-PEi particles, owing to electrosteric effects of the PEi. The zeta potential was measured to be +65 mV.

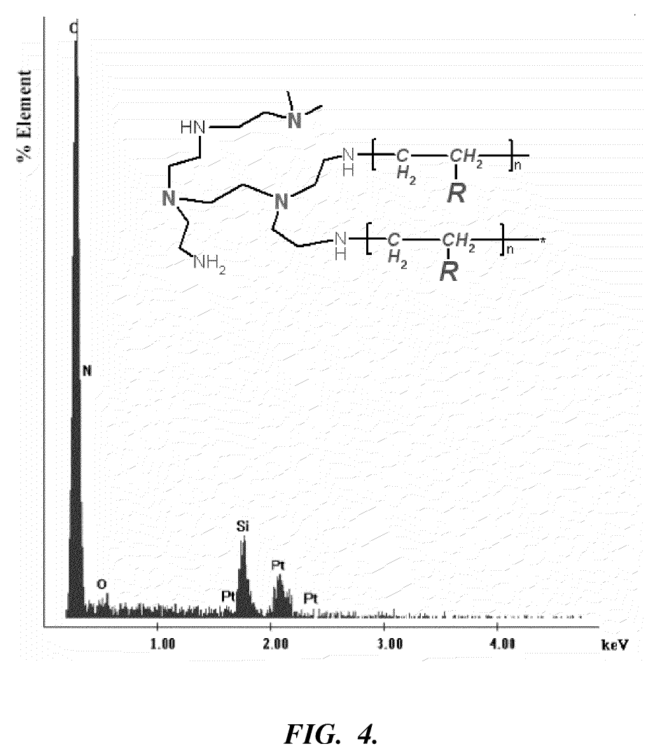

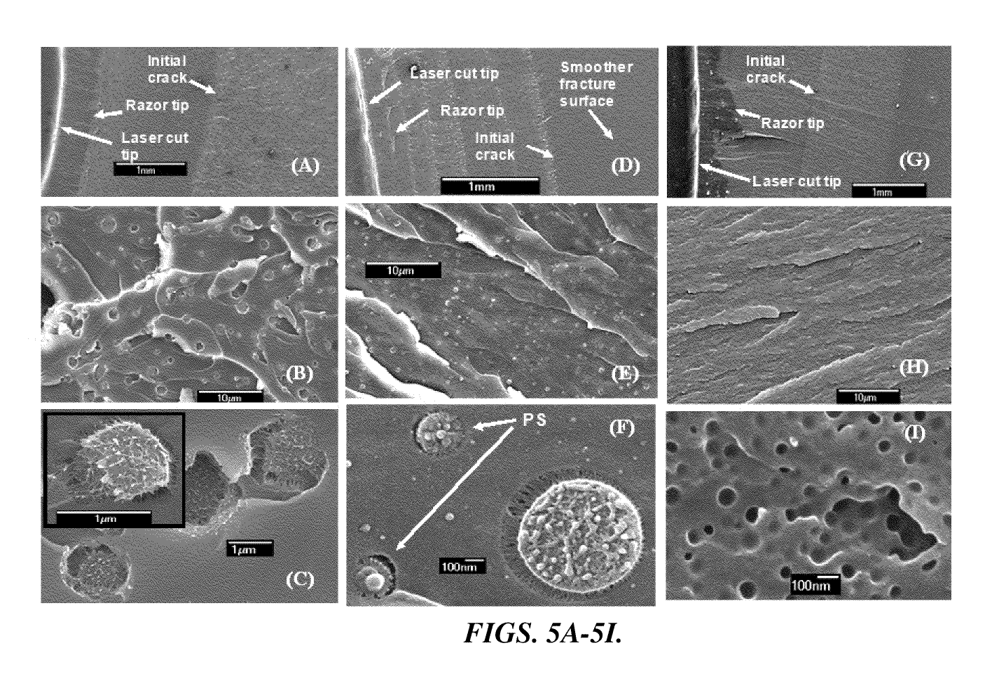

In addition, core/shell composition of the particles at the ratio of 5 was confirmed by energy dispersive x-spectroscopy (EDS) in FIG. 4, where the peak height ratio of carbon to nitrogen was approximately 2.5. Recall that in the dendrimer structure, for every nitrogen atom, there are two carbon atoms. Upon a successful linkage, eight more carbon atoms are added to the dendrimer structure. Consequently, the observed peak ratio indicated that there was a thick shell for this type of particle. This is confirmed in FIG. 5C.

### Example 2

### Preparation and Characterization of an Epoxy Comprising PS-PEi Particles

Materials. EPON™ Resin 828, with an epoxy equivalent weight of 189, purchased from Miller-Stephenson (Los Angeles, Calif.), and Ethacure® 100, with an amine equivalent weight of 44, supplied by Albemarle Corp., Baton Rouge, La., were used as the base materials. Particles as prepared by the method of Example 1 were employed.

A desired amount (e.g., 2.5-25% by weight) of the concentrated particle dispersion was blended with 400 g of epoxy resin in a 1 L-vacuum flask submerged in a 85° C.-water bath under vacuum and vigorously stirred for 45 min to remove most of the IPA. Curing agent (96 g) was then added. After the rest of the solvent was removed (˜15 min), the mixture was poured into a preheated glass mold with Teflon® inserts. The curing cycle was set at 2 hr at 120° C., followed by 3 hr at 182° C.

Discussion. As seen from the structure of PEi (FIG. 1), primary amines form a shell while both secondary and tertiary amines compose a core. Upon interacting with epoxy, each hydrogen of the second and primary amines can take on an epoxy ring, resulting in a more complicated crosslink network with the epoxy upon curing than the previous used materials. These short and small crosslinks behave like multileveled springs which not only absorb energy but retain the stiffness of the epoxy as well.

### Example 3

### Mechanical Tests of an Epoxy Comprising PS-PEi Particles

PS-PEi particles and epoxy comprising these particles were used as prepared in Examples 1 and 2. Core-shell rubber (CSR) particle toughened epoxy, MX125, provided by Kaneka Corp. (Houston, Tex.) was chosen for property comparisons.

Fracture Toughness Test Methods. Fracture toughness analysis was carried out according to the American Society for Testing and Materials (ASTM) D 5045-99. Rectangular specimens were cut from a molded plate and machined to dimensions of 120×16×6.2 mm. An edge notch was initially made by a red laser cutter (Universal Laser System, Scottsdale, Ariz.) to a length of 6 mm, followed by forcing a razor blade into the slot and tapping it with a hammer to create a sharp crack tip. The setting for the laser was 85% in power, 5% in speed, and 10 passes. The final crack length (a) was approximately 8 mm.

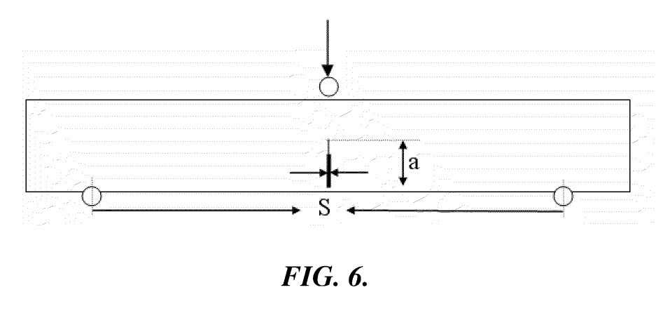

FIG. 6 shows a schematic of the mechanical test specimen examined using a Satec T-1000 mechanical tester (Satec Systems, Inc., Grove City, Pa.). The span (S) was set at 70 mm. The load was applied such that the centerline of the plunger aligned with the centerline of the notch. The crosshead was adjusted until the plunger contacted the sample at 1 N. Crosshead speed was set at 0.5 mm/min. At least five specimens were tested per sample. Fracture toughness (K_{IC}) was determined from the maximum load (P_{c}) and specimen geometries as

$${K}_{IC} = \frac{{P}_{c}}{{W}^{1 / 2} t} f ( x )$$

where t and W are the specimen thickness and width, respectively, and f(x=a/W) is a geometric correction factor. f(x) is defined as

$$f ( x ) = 1.5 ( \frac{S}{W} ) {x}^{1 / 2} \frac{1.99 - x ( 1 - x ) ( 2.15 - 3.93 x + 2.7 {x}^{2} )}{( 1 + 2 x ) {( 1 - x )}^{3 / 2}}$$

Calculated K_{IC} values must satisfy the following conditions, where σ_{y} is the yield stress.

0.45<a/W<0.55;

t,a,W−a>2.5(K_{IC}/σ_{y})²,

Flexural Test Methods. Flexural test analysis was carried out according to ASTM D 790-03. Sample preparation was similar to that used in the fracture toughness test, but without the notch. The specimen was machined to 20×10×6.2 mm with smooth edges. In this test, the specimen was placed flatwise instead of edgewise, as seen in the fracture toughness test. The crosshead was adjusted until the plunger contacted the sample at 5 N, and crosshead speed was set at 1.5 mm/min. At least five specimens were tested for each material. Flexural strength (σ_{f}) and modulus (E_{f}) were determined as follows:

$${σ}_{f} = \frac{1.5 S {σ}_{c}}{t}$$

$${E}_{f} = \frac{{S}^{3} m}{4 {t}^{2}}$$

where σ_{c} is the maximum stress (either yield stress or stress at break) and m is the slope of the tangent line to the initial portion of the stress-crosshead movement curve.

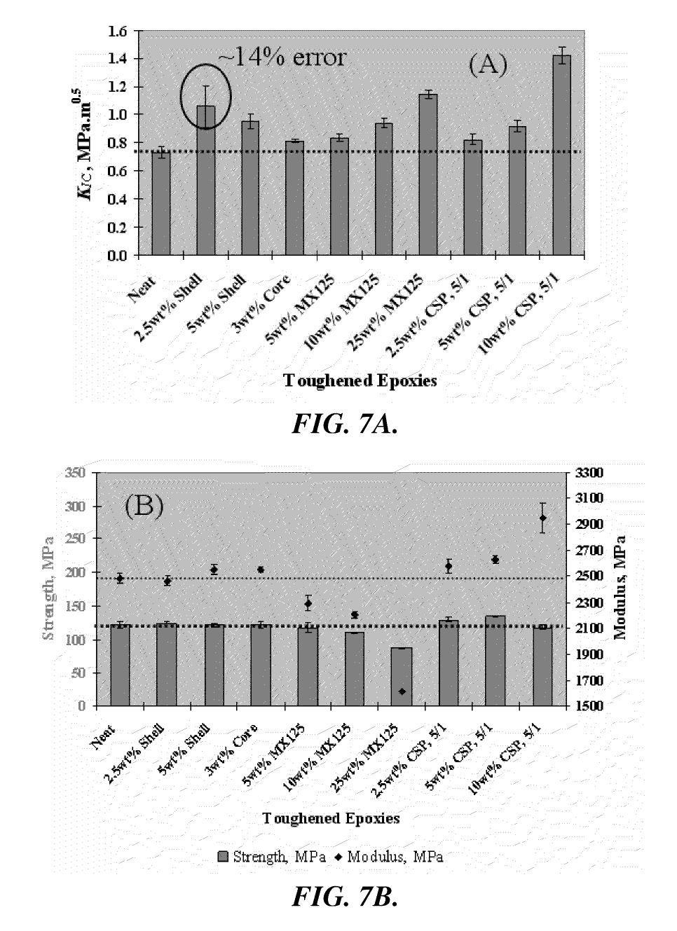

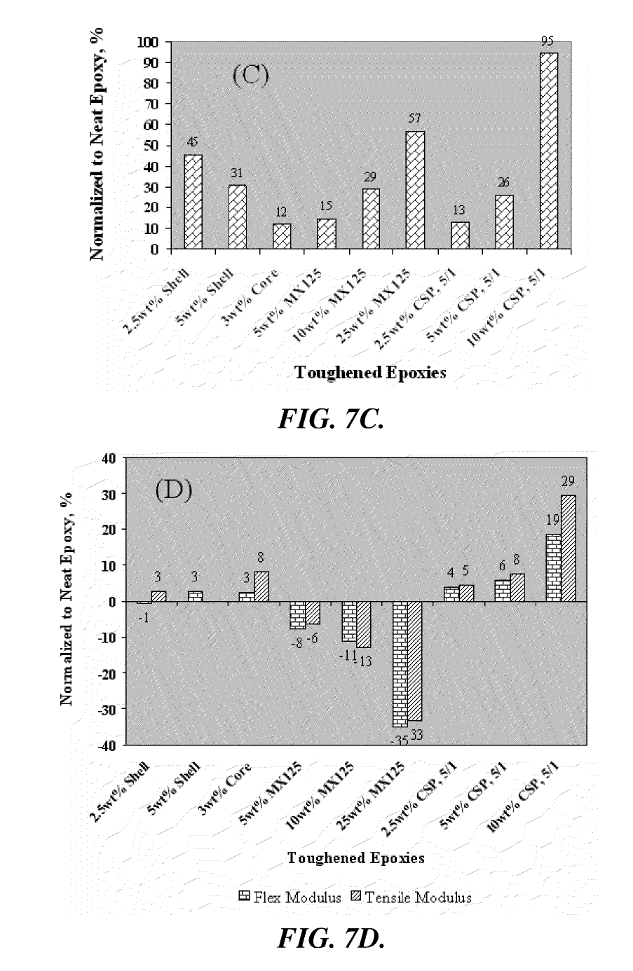

Results. PEi alone, PS alone, CSR, and PS-PEi particles were loaded at 2.5-5%, 3%, 5-25% and 2.5-10 wt %, respectively. As shown in FIGS. 7A, 7B a variation of less than 5% was obtained for flexural strength, modulus and K_{IC}. The variation in the flexural test came mostly from micro-roughness at the edges of the machined sides, while that in the fracture toughness test was due to the difficulty encountered in measuring the exact crack length a. In some cases, e.g., 2.5 wt % PEi, higher error bars were found, owing to the difficulty of creating a uniformly sharp crack front. For these cases, more than 5 specimens per sample were tested. All toughened epoxy samples showed an enhancement in K_{IC}(FIGS. 7A, 7C), and K_{IC} increased as the particle loading increased.

It was noticed that some samples at high loadings (>10 wt %) showed yielding; therefore the yield strength was reported instead of the ultimate strength (at break), which is lower. These values were smaller than those obtained with the neat epoxy, while similar strengths were found in all other samples (FIG. 7B). In addition, unexpectedly, there was a large increase in flexural modulus as PS-PEi particle loading was increased, and no drop in the PS- and PEi-toughened epoxy samples. This trend was confirmed with tensile modulus measurements (FIG. 7D). This was surprising, since generally when a soft material is incorporated into an epoxy for the purpose of toughening, a corresponding reduction in stiffness is observed, as seen in all the CSR samples.

### Example 4

### Surface Comparison of PS, PEi and PS-PEi Particles

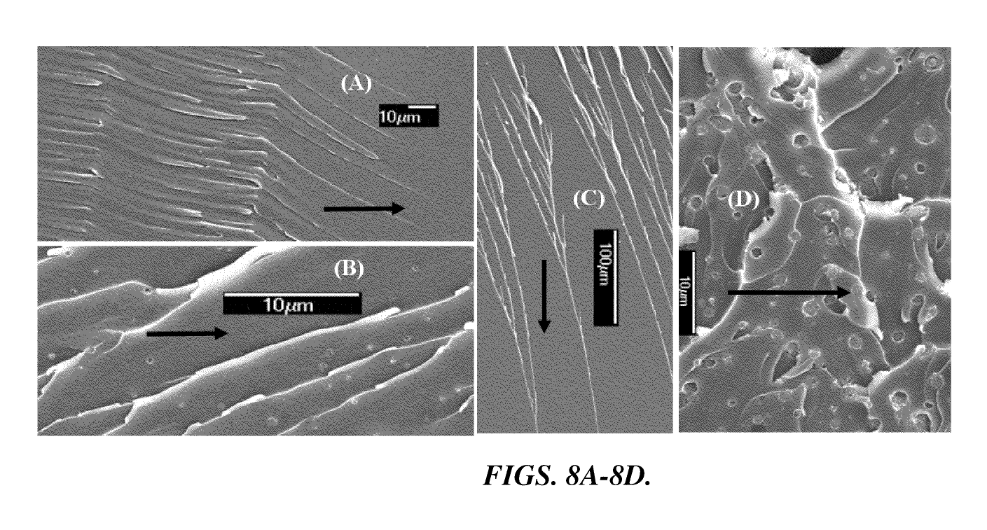

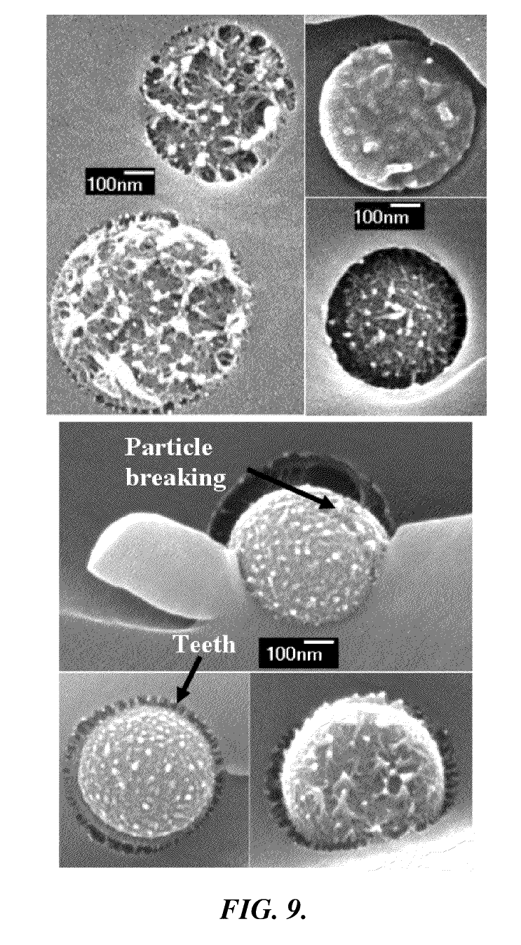

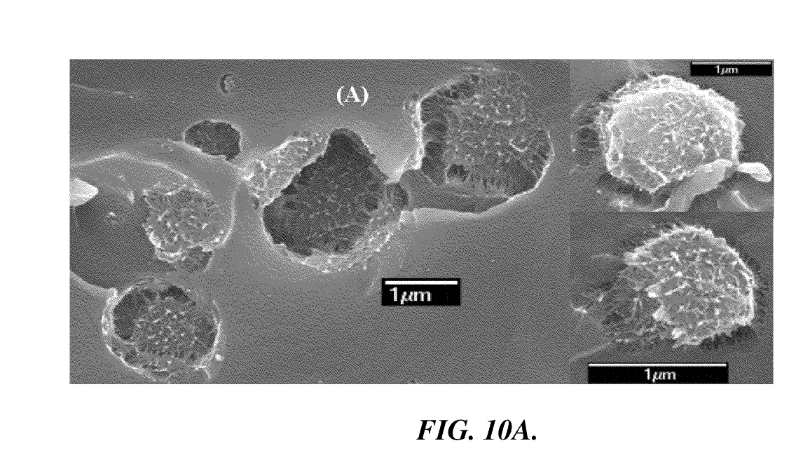

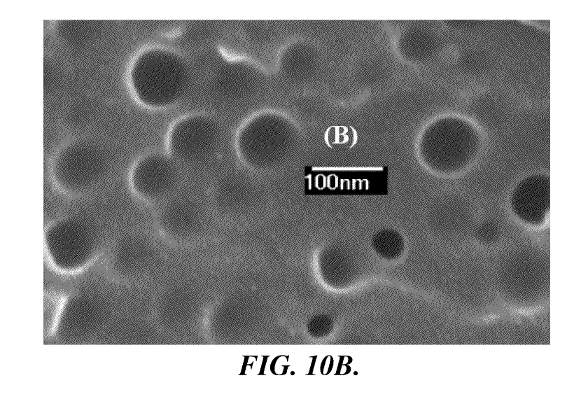

FIG. 8 shows the fracture surfaces of neat, core-, shell- and PS-PEi particle-toughened epoxy samples at low magnification. Arrows indicate the crack front propagation directions. In all cases, cracks propagated in parallel planes. However, cracks were directed in many paths when PEi was reacted with PS particles, as shown for the case of 10 wt % PS-PEi particle sample. Similar behavior was observed at lower PS-PEi particle loadings with a smaller number of crack paths. Compared to the SEM micrographs of the 3 wt % PS (FIG. 9) and 25 wt % MX125 (FIG. 10B) samples, particle breaking and dramatic particle-matrix interface stretching found in the 10 wt % PS-PEi particle sample (FIG. 10A) as opposed to cavitation and particle stretching (PS particles) and crack bowing/massive shear band formation (MX125 particles), indicated by the white area around these rubber particles, as well as some degree of particle stretching, were responsible for a significant increase in K_{IC}. It can be argued that crack energy was absorbed to debond the particle. However, due to the structure of the reactive amine dendrimer a substantial amount of energy was required. The triaxial interfacial stress was built up so much that provoking particle-bridging followed by particle-breaking mechanisms was most likely to relieve it. This acquired a great deal of additional energy, and the fracture toughness enhancement was attributed to the high population of large particles (FIG. 8D). This unique energy-absorbing effect was also found in other PS-PEi particle samples, which explains the considerable increase in fracture toughness compared to the CSR samples, especially at 10 wt % loading (FIG. 7C), even higher than the 25% MX125 sample.

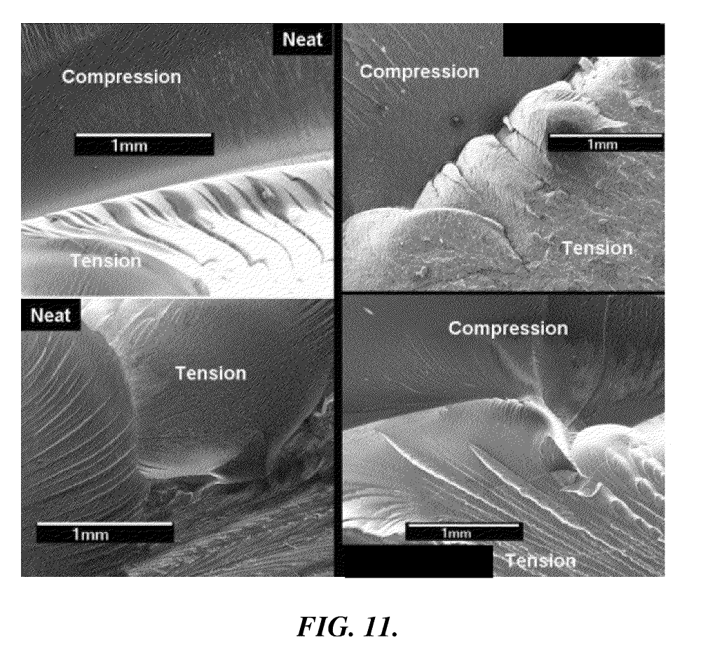

The mechanisms described above are also believed to be the cause of an increase in the flexural and tensile moduli of PS-PEi particle-toughened epoxies in that an enormous number of different amine-level short branches of the shell act as little springs, more rigid than the epoxy/curing agent networks, to not only absorb crack energy but also ‘harden’ the soft PS core. The latter was achieved by directing cracks through the core or diverting cracks to go through many paths, resulting in a ‘rock-like’ surface, as opposed to smooth surfaces with parallel cracks in the neat and 10 wt % MX125 samples (FIG. 11). This is made possible due to the interpenetration and chemical interactions among PEi, epoxy and PS networks. Again, this stress transfer mechanism is a unique characteristic of the present dendrimer.

### Example 5

### Experiments Studying Various Core-to-Shell Ratios of PS-PEi Particles and Their Inclusion in Epoxy

Methods. PS-PEi Particles of varying core-to-shell ratios (2.5:1, 5:1, 10:1) were analyzed alone, and properties of epoxy comprising these various particles were studied. Methods of preparing these particles is discussed in Example 1, and inclusion of these particles in epoxy is discussed in Example 2.

When the reaction dispersions were heated under vacuum to evaporate some of the IPA before mixing with the epoxy, some complications were noted such as the presence of some small particles (also noted in Example 1) and an observed increase in viscosity upon mixing. It is hypothesized that the small particles, nucleated during heating, were due to excess reactant materials present in the final dispersion and/or coalescence of particles, followed by size disproportionation. These small particles are generally believed to neither contribute nor detract from the energy-absorbing effects for lower core-to-shell ratios, although there might be some contribution in the case of core-to-shell ratio of 10, where many PS particles were present.

The increase in viscosity can be traced to the unreacted dendrimers. As 10 wt % PS-PEi particles were loaded to the epoxy/curing agent system, not much change in viscosity at 80° C. was observed when most of IPA was removed (indicated by no bubbling in the mixture). Moreover, when the mixture was cooled to room temperature, its viscosity was lower than that of the as-is epoxy for a few hours. After 5-10 min upon complete removal of IPA (i.e., 10-20 min after no bubbles present in the mixture), however, the mixture gelled up quickly and was difficult to transfer from the 1 L flask to the mold, especially in the case of core-to-shell ratio of 2 in that no particle loading greater than 5 wt % was made successfully. Since the unreacted dendrimers neither contribute to nor detract from the mechanical property enhancement of PS-PEi particles as previously studied, they should have been removed upon the completion of the reaction process. Recall that excess styrene monomers might also be present in the reactor. However, in such a vacuum-evaporation process a major amount of unreacted styrene monomers were also removed, although their presence would not affect the mechanical properties, but lower the mixture viscosity. This was observed with the core-to-shell ratio of 10 in which PS-PEi particle loadings higher than 10 wt % could easily be incorporated.

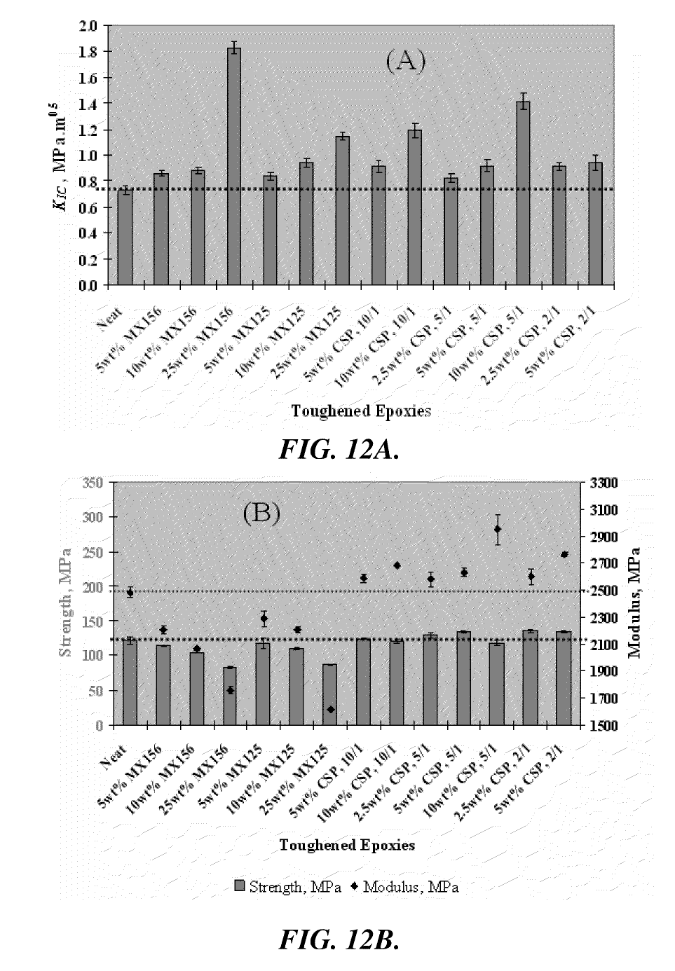

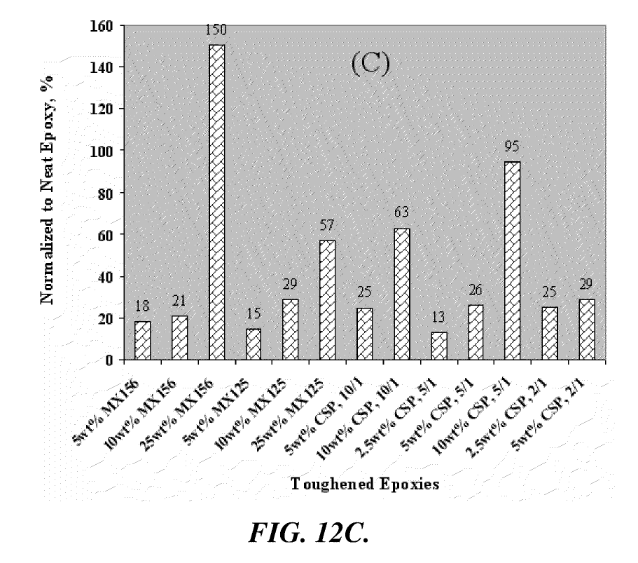

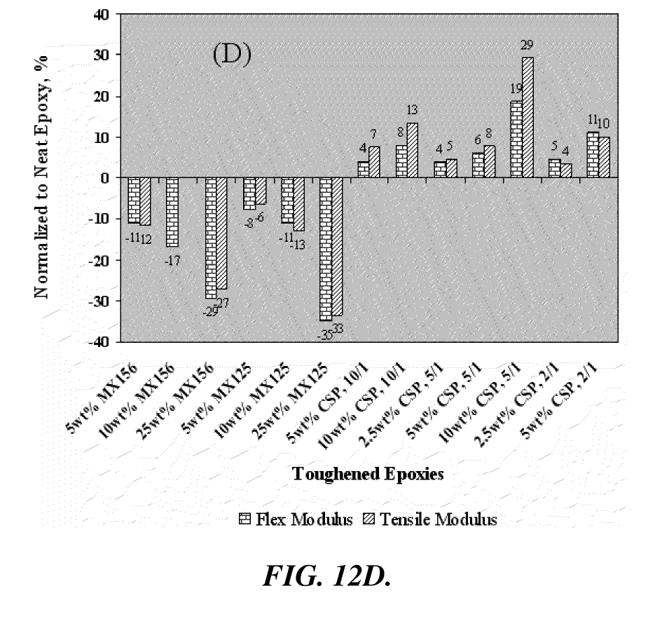

Mechanical Test Results in Dry Conditions. Kaneka CSR particles (MX125 and MX156) were loaded in the epoxy from 5 to 25 wt %. PS-PEi particles with core-to-shell ratios of 10, 5 and 2 were incorporated in the epoxy at 5 and 10 wt %, 2.5-10 wt %, and 2.5% and 5 wt %, respectively. As shown in FIGS. 12A, 12B a variation of less than 5% was obtained for flexural strength and modulus, and K_{IC}. The variation in the flexural test came mostly from micro roughness at the edges of the machined sides, while that in the fracture toughness test was due to the difficulty encountered in measuring the exact crack length a. The error bars associated with the latter might be magnified if there is also difficulty in creating a uniformly sharp crack front, commonly reported to the literature, owing to not allowing the crack front to advance far enough from the machined slot's tip.

All toughened epoxy samples showed an enhancement in K_{IC}(FIG. 12C), and K_{IC} increased as the particle loading increased. Generally, as the core-to-shell ratio increases, K_{IC} is lower. PS-PEi particle samples show a greater enhancement compared to the CSR at the same loading or higher. In some cases, K_{IC} remained unchanged at either higher loadings, e.g., PS-PEi particles at 2:1 (2.5, 5 wt %) and MX156 (5, 10 wt %) or different core-to-shell ratios at 5 wt %. It is believed that there may be a minimal particle interspacing for the toughening to be most effective.

Previous trends in both flexural strength and stiffness were observed among CSR- and PS-PEi particle-toughened epoxy samples (FIGS. 12B, 12D). All CSR samples showed a decrease in stiffness with respect to particle loading, while the opposite was true with PS-PEi particle samples. At 10 wt % loading, a significant increase in stiffness was obtained with both core-to-shell ratios of 5 and 10. Again, the effect of core-to-shell ratio on stiffness was observed.

Particle Enhancing Mechanical Properties Studied by SEM. The incorporation of particles either harder or softer than a matrix may provoke a number of toughening mechanisms to dissipate crack energy. The more effective particles constitute larger energy sinks. Evidence for energy-absorbing mechanisms pertaining to PS-PEi particles can be deduced from FIG. 5. Particle breaking and dramatic particle-matrix interface stretching, as opposed to massive shear-band formation, indicated by the white area around these rubber particles, and some degree of particle stretching, are responsible for a significant increase in K_{IC}. This unique energy-absorbing effect was found in all of the PS-PEi particle samples, which explains the considerable increase in fracture toughness compared to the CSR samples, especially at 10 wt % loading, even higher than that of the 25% MX125 sample. A higher loading of PS-PEi particle samples is believed to out-perform the toughest 25 wt % MX156 sample in which the core is composed of polybutadiene (PB) rather than the copolymer block of PB/PS in MX125. Moreover, it is evidenced from the fracture surfaces of 10 wt % PS-PEI particles at 5:1 and 10:1 that the lower the core-to-shell ratio or the thicker the shell, the more effective the mechanical property enhancement. In the latter, PS particles were also found, and the core was distinguishable from the shell. In the former, however, both core and shell materials were well-blended, which appeared to produce better energy sink (i.e., contributes to a higher fracture toughness) and harder (i.e., contributes to a higher stiffness) as well.

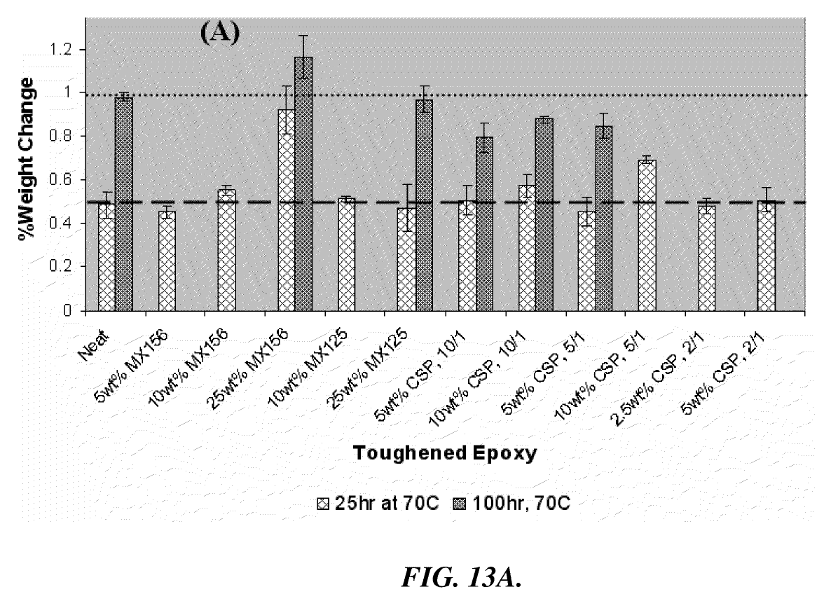

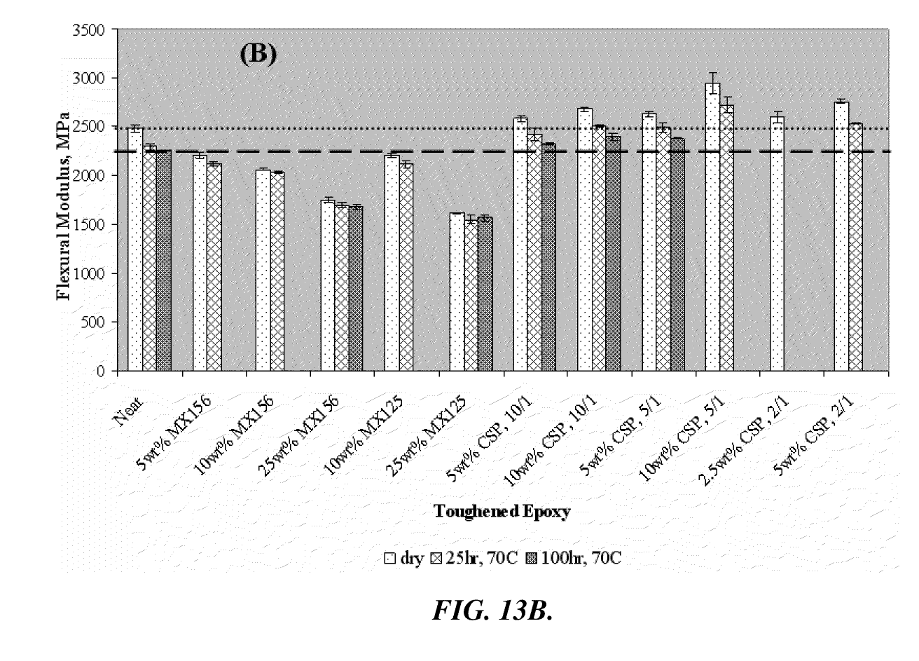

Performance in Hostile Environments. Shown in FIG. 13A is the percent of water uptake when selected samples were submerged in 70° C. water for 25 and 100 hrs. It was believed that the rate of uptake was dominated by surface morphology at early stages, and the material chemistry took over later on. Trapped water molecules in the epoxy/curing agent network can migrate and might be held at both the particle/matrix interface and in the particle structure. As time proceeds, saturation occurs, i.e., weight change reaches a plateau with respect to time. A similar amount of water absorption was observed for all samples after 25 hr. All toughened samples also showed a little increase in weight compared to the neat resin. A higher weight increase was observed at the longer time for all samples and whether or not they approached the saturation point was undetermined. An increase of less than 1% was found after 100 hr, and PS-PEi particle samples outperformed the neat and CSR samples.

Performance in hostile environments above all was reflected in the mechanical properties. Shown in FIG. 13B is the plot of flexural modulus in both dry and wet-conditioned cases. For all samples, a reduction less than 10% were obtained. Even so, PS-PEi particle samples still significantly outperformed both the neat and CSR samples.

### Example 6

### Studies of Epoxies Comprising PS-PEi Particles and Styrene Monomers

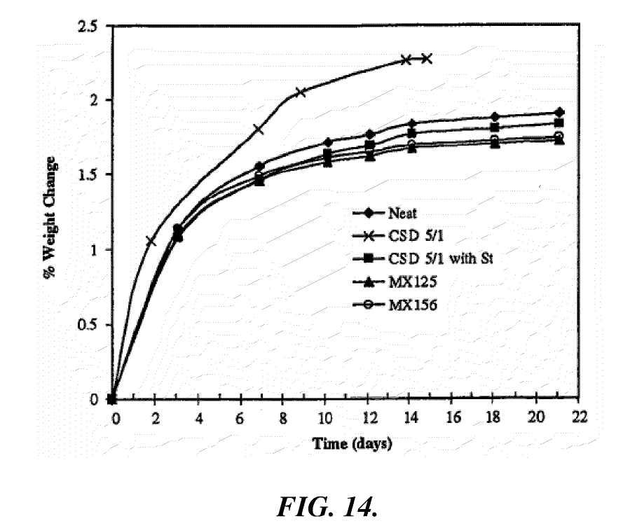

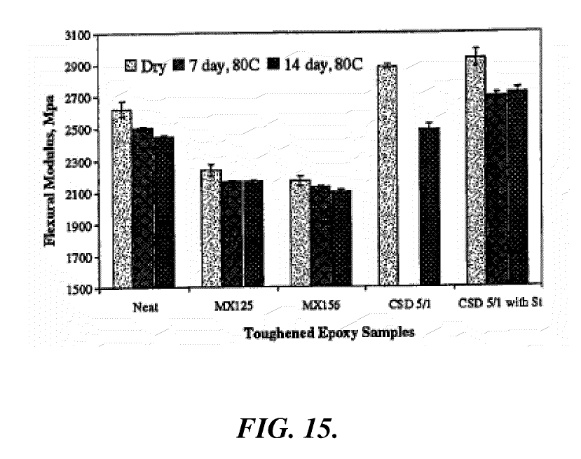

Additional experiments were performed under hot-wet conditions (see Example 5). PS-PEi particles (5:1 styrene:PEi by weight) in epoxy were submerged in 80° C. water for up to three weeks. Results showed that weight change increased rapidly in the first four days, and a saturation point was reached within the first week. A great reduction in water uptake (to a level even lower than that in the neat epoxy) resulted with the addition of a small amount (10 parts by weight) of styrene monomer. See FIG. 14. Modest decreases in modulus due to hot-wet conditioning for up to two weeks were observed for the neat epoxy and for the CSR particle reinforced samples. The PS-PEi particle-containing samples showed a reduction in modulus of approximately 20% after hot-wet conditioning, but still outperformed the CSR particle reinforced samples and the neat epoxy with respect to this property. The use of styrene in the PEi-PS particle samples, however, cut the reduction in modulus to about half its value in the absence of the styrene. See FIG. 15.

While illustrative embodiments have been illustrated and described, it will be appreciated that various changes can be made therein without departing from the spirit and scope of the invention.

The embodiments of the invention in which an exclusive property or privilege is claimed are defined as follows:

1. A particle comprising:
(a) a core comprising a plurality of polymerized vinyl monomers; and
(b) a shell comprising at least one polyamine polymer, wherein each polyamine polymer consists of a plurality of primary amines, a plurality of secondary amines, and optionally at least one tertiary amine, and each nitrogen atom of each primary amine, secondary amine, and optional tertiary amine is separated by an alkylene group

2. A method of making a particle, comprising polymerizing a plurality of vinyl monomers in the presence of a non-aqueous polar solvent and a plurality of polyamine polymers,
wherein each polyamine polymer consists of a plurality of primary amines, a plurality of secondary amines, and optionally at least one tertiary amine, and each nitrogen atom of each primary amine, secondary amine, and optional tertiary amine is separated by an alkylene group,
to provide a particle comprising:
(a) a core comprising a plurality of polymerized vinyl monomers; and
(b) a shell comprising at least one polyamine polymer, wherein each polyamine polymer consists of a plurality of primary amines, a plurality of secondary amines, and optionally at least one tertiary amine, and each nitrogen atom of each primary amine, secondary amine, and optional tertiary amine is separated by an alkylene group.

3. The method of claim 2, wherein the polymerized vinyl monomers are further defined as elastomers, thermoplastic monomers, or a combination thereof.

4. The method of claim 2, wherein the vinyl monomers are selected from the group consisting of styrene, methylmethacrylate (MMA), benzylmethacrylate (BMA), butadiene sulfone (BSF) and 1,3,5,7-tetravinyl-1,3,5,7-tetramethylcyclotetrasilane.

5. The method of claim 2, wherein the shell comprises a linear polyamine polymer, a branched polyamine polymer, or a polyamine dendrimer.

6. The method of claim 2, wherein the branched polyamine polymer is further defined as a hyperbranched polyamine polymer.

7. The method of claim 2, wherein the shell comprises a polyalkyleneimine dendrimer.

8. The method of claim 7, wherein the polyalkyleneimine dendrimer is further defined as polyethyleneimine (PEi) dendrimer.

9. The method of claim 8, wherein the average molecular weight of PEi dendrimer is about 750,000 Da.

10. The method of claim 2, wherein the particles have an average diameter of less than 500 nm.

11. The method of claim 10, wherein the particles have an average diameter ranging between about 200-300 nm.

12. The method of claim 2, wherein the particles have a zeta potential in isopropyl alcohol ranging between about 60-70 mV.

13. The method of claim 2, wherein the weight ratio of vinyl monomer to the polyamine polymer ranges from about 1:1 to about 50:1.

14. The method of claim 13, wherein the weight ratio of vinyl monomer to the polyamine polymer ranges from about 2:1 to about 10:1.

15. The method of claim 13, wherein the weight ratio of vinyl monomer to the polyamine polymer ranges from about 5:1.

16. The method of claim 2, wherein the vinyl monomer is further defined as styrene, the polyamine polymer is further defined as PEi dendrimer, and the weight ratio of styrene to PEi is about 5:1.

17. The method of claim 2, wherein the non-aqueous polar solvent has a boiling point above about 45° C.

18. The method of claim 2, wherein the non-aqueous polar solvent is further defined as isopropyl alcohol.

19. The method of claim 2, wherein polymerizing a plurality of vinyl monomers in the presence of a non-aqueous polar solvent and a plurality of polyamine polymers comprises radical initiated polymerization.

20. A particle made by the method of claim 2.

21. A polymer composite, comprising a plurality of particles of claim 1.

22. The polymer composite of claim 21, further defined as an epoxy comprising a plurality of particles of claim 1.

23. The polymer composite of claim 22, wherein the epoxy comprises at least 0.5 weight percent of particles of claim 1.

24. The polymer composite of claim 22, wherein the epoxy comprises from about 2-25 weight percent of particles of claim 1.

25. The polymer composite of claim 23, wherein the epoxy comprises at least about 10 weight percent of particles of claim 1.

26. The polymer composite of claim 23, further comprising about 5-15 parts by weight of styrene monomers.

27. An epoxy having a fracture toughness (K_{IC}) of at least about 1.3 MPa.m^{0.5} and a flexural modulus of at least about 2900 MPa.

28. The epoxy of claim 27, further comprising a plurality of particles of claim 1.

29. The epoxy of claim 28, further comprising about 5-15 parts by weight of styrene monomers.

30. A method for making a polymer composite of claim 21, comprising combining a plurality of particles of claim 1 with an amine-reactive polymer and a curing agent to produce a polymer composite of claim 21.

31. The method of claim 30, wherein the polymer composite is further defined as an epoxy comprising a plurality of particles of claim 1.

32. The method of claim 31, wherein the weight percent of particles combined with the amine-reactive polymer and curing agent is at least 0.5%.

33. The method of claim 31, wherein the weight percent of particles combined with the amine-reactive polymer and curing agent is at least about 10%.

34. The method of claim 31, wherein the particles of claim 1 are further defined as particles having a polystyrene (PS) core and a polyethyleneimine (PEi) dendrimer shell, wherein each PEi dendrimer is covalently coupled to the core through an —NH—CH₂— bond.

35. The method of claim 30, wherein the plurality of particles of claim 1 are dispersed in a non-aqueous polar solvent prior to combination with the amine-reactive polymer and the curing agent.

36. The method of claim 35, wherein the particle concentration, in terms of grams of sold/gram of dispersion, in the non-aqueous polar solvent ranges from about 10-15%.

37. The method of claim 34, further comprising heating the mixture formed by the combination of the plurality of particles dispersed in a non-aqueous polar solvent, amine-reactive polymer and curing agent at a temperature sufficient to remove the non-aqueous polar solvent.

38. The method of claim 30, further comprising addition of about 5-15 parts by weight of styrene monomers prior to curing.

39. The method of claim 30, further comprising curing the polymer composite.

40. A method of reducing water-uptake of an epoxy comprising a particle of claim 1, comprising adding about 5-15 parts by weight of styrene monomers to said epoxy prior to curing.

41. A method of improving the flexural modulus of an epoxy comprising a particle of claim 1, comprising adding about 5-15 parts by weight of styrene monomers to said epoxy prior to curing.
